(19) United States
(12) Patent Application Publication
(10) Pub. No.: US 2024/0263538 A1
(43) Pub. Date: Aug. 8, 2024

(54) MULTI-PLATE MANIFOLD

(71) Applicant: The Oilgear Company, Traverse City, MI (US)

(72) Inventors: Louis Plamondon, Traverse City, MI (US); Moyo Terebo, Williamsburg, MI (US); Jared Schlueter, Traverse City, MI (US)

(21) Appl. No.: 18/435,712

(22) Filed: Feb. 7, 2024

Related U.S. Application Data
(60) Provisional application No. 63/443,745, filed on Feb. 7, 2023.

(51) Int. Cl. E21B 33/12; B23P 19/08

(52) U.S. Cl. CPC E21B 33/1208; B23P 19/084

(57) ABSTRACT

A manifold having a first sub-manifold defining a first fluid passage, a second sub-manifold defining a second fluid passage, and a seal-sub occupying an interface between the first and second fluid passage and that seals against the first and second fluid passages to prevent fluid leaks at the interface. The first sub-manifold defines an opening for receiving the seal-sub into the first fluid passage from outside the first sub-manifold that is separate from the interface.

### CROSS-REFERENCE TO RELATED CASES

This application claims the benefit of U.S. provisional patent application Ser. No. 63/443,745, filed on Feb. 7, 2023, and incorporates such provisional application by reference into this disclosure as if fully set out at this point.

### FIELD OF THE INVENTION

This disclosure relates to hydraulic devices in general and, more particularly, to a multi-plate hydraulic manifold.

### BACKGROUND OF THE INVENTION

When control or operation signals are sent hydraulically from an off shore drilling rig, oil platform, or similar device to a subsea device or operation, the hydraulic signals may be ported through a manifold to effect their various designated operations or functions. These functions may include operation of items such as shear rams, annulars, and other critical subsea functions.

Blow out preventer (BOP) control systems, and other control systems, may utilize one or more manifolds for distribution of hydraulic control signals or power. Prior art manifolds have shown serious reliability concerns, many have a proven history of failure for various reasons known in the art. For example, where multiple components are assembled into a complete manifold, prior art manifold arrangements seal the connecting manifold faces with individual seals, or gasket type seal plates, to make a face seal between the connecting components. A traditionally constructed face seal will easily extrude and fail with as little as ten thousandths of an inch of separation between the sealed components. Pressure spikes in the hydraulic system can potentially stretch connecting bolts and cause this slight amount of separation. A loss of sealing integrity on the manifold could result in a loss of control of the BOP or other device. Such manifold would then need to be pulled from the well head to prevent further undesirable consequences.

In addition to problems resulting from loss of sealing integrity due to pressure spikes, many documented failures with prior manifolds are related to difficulty in properly assembling prior art devices.

What is needed is a system and method for addressing the above and related concerns.

### SUMMARY OF THE INVENTION

The invention of the present disclosure, in one aspect thereof, comprises a manifold having a first sub-manifold defining a first fluid passage, a second sub-manifold defining a second fluid passage, and a seal-sub occupying an interface between the first and second fluid passage and that seals against the first and second fluid passages to prevent fluid leaks at the interface. The first sub-manifold defines an opening for receiving the seal-sub into the first fluid passage from outside the first sub-manifold that is separate from the interface.

The manifold may further comprise first and second pairs of indexed openings defined in the first and second sub-manifolds that receive first and second alignment pins with the first and second fluid passages are aligned.

The seal-sub may have a first end with at least one seal contacting the first fluid passage and at least one seal contacting the second fluid passage. The seal-sub may comprise first and second cylindrical ends spaced apart and interposed by a medial portion, the medial portion being recessed to define a flow region in the first passage. The first end of the seal-sub may define a central passage in fluid communication with the first fluid passage. The first end of the seal-sub may define a port providing fluid communication between the central passage and the flow region.

The manifold may further comprise a plug fitting into the opening in the first manifold for receiving the seal-sub that retains the seal-sub in position at the interface between the first and second fluid passages. In some cases, the interface between the first and second fluid passages is defined at a joining of first and second seal faces of the first and second sub-manifolds, respectively. The first and second seal faces may be planar.

The manifold may include a leak indicating drain channel in the first seal face leading from the interface between the first and second fluid passages to a location beyond the first and second seal faces. The manifold may include a leak indicating drain channel in the second seal face leading from the interface between the first and second fluid passages to a location beyond the first and second seal faces.

The invention of the present disclosure, in another aspect thereof, comprises a method of joining first and second sub-manifolds defining first and second fluid passages, comprising. The method includes providing first and second seal faces on the first and second manifolds, the first and second fluid passages terminating at the first and second seal faces, respectively, placing alignment openings passing through the first sub-manifold and into the second manifold when the first and second fluid passages are aligned, and placing alignment pins into the alignment openings. The method includes defining an exterior opening into the first fluid passage that is accessible from outside the first sub-manifold through a location other than the first seal face, providing a seal-sub having an elongate body with first and second ends spaced apart by a recessed medial portion, the first end defining a central passage and a port from the central passage to an outside of the medial portion, inserting the seal-sub into the exterior opening and into a position where the first end passes through the first and second seal faces, and fastening the first and second seal faces into a fixed position with respect to one another.

The method may further comprise retaining the seal-sub in the position where the first end passes through the first and second seal faces by inserting a plug into the exterior opening. The method may comprise retaining the seal-sub in the position where the first end passes through the first and second seal faces by providing a shoulder in the second passage. The method may comprise retaining the seal-sub in the position where the first end passes through the first and second seal faces by providing cooperating tapered regions in the first fluid passage and the first end of the seal-sub.

The invention of the present disclosure, in another aspect thereof, comprises a seal-sub for connecting adjacent first and second hydraulic passages into first and second seal faces of a manifold. The sub-seal includes a first end occupying a portion of both the first and second passages and defining a central passageway therein, a second end spaced apart from the first end and extended into the first hydraulic passage, a medial portion interposing the first end and second end and having a diameter smaller than the first end and smaller than the second end to define a flow space between the first end and the second end inside the first hydraulic passage; and at least one port providing fluid communication between the flow space and the central passageway.

The first end and the second end of the seal-sub may be at least partially cylindrical. The second end may be at least partially cylindrical and taper between first and second diameters. At least one port is defined by a plurality of vanes between the medial portion and the second end. The seal-sub of claim 1 may include at least a first o-ring interposing the second end and the first passage and at least a second o-ring interposing the second end and the second passage.

### BRIEF DESCRIPTION OF THE DRAWINGS

FIG. 1 is an overhead plan view of a multi-plate manifold according to aspects of the present disclosure.

FIG. 2 is a partially exploded perspective view of the multi-plate manifold of FIG. 1.

FIG. 3 a partially exploded perspective end view of the multi-plate manifold of FIG. 1.

FIG. 4 is a close up, side cutaway view illustrating a seal-sub adjoining hydraulically interconnecting adjacent sub-manifolds according to aspects of the present disclosure.

FIG. 5 is an end view of the multi-plate manifold of FIG. 1.

FIG. 6 is a side view of the multi-plate manifold of FIG. 1.

### DETAILED DESCRIPTION OF THE PREFERRED EMBODIMENTS

In various embodiments, the present disclosure describes a manifold system and method for distributing hydraulic fluids to designated hydraulic functions. The systems and methods of the present disclosure may provide solutions for implementing hydraulic power, control, and/or signally from an off shore drilling rig, oil platform, or similar device to one or more subsea devices or operations. In some cases, the systems and methods of the present disclosure are not limited to the specific applications identified above, but may find use in other hydraulic systems utilizing a manifold as part of one or more hydraulic circuits.

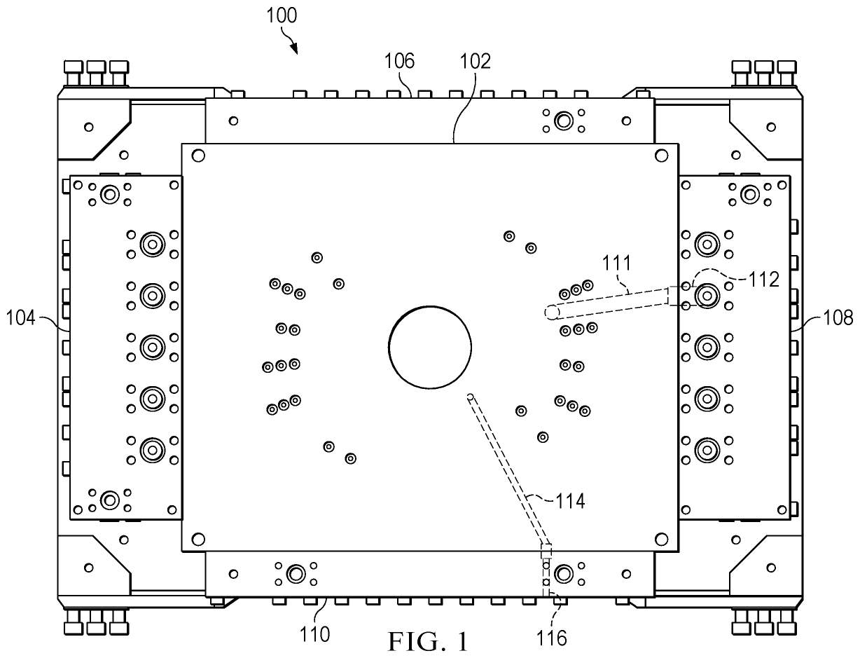

Referring now to FIG. 1, a plan view of a multi-plate manifold 100 according to aspects of the present disclosure is shown. The multi-plate manifolds of the present description may comprise a number of separate sub-manifolds or plates. The multi-plate manifold 100 comprises five sub-manifolds 102, 104, 106, 108, 110. Other embodiments may have more or fewer sub-manifolds. The design of the multi-plate manifold 100 may be modular such that the sub-manifolds 102, 104, 106, 108, 110 can be separated for field repair (e.g., on board the associated rigg) or for other reasons. A frame 120 may provide a connection point for lifting, moving, and servicing the manifold 100 and may be variously connected to one or more of the sub-manifolds 102, 104, 106, 108, 110.

In the illustrated embodiment, a central sub-manifold 102 provides a connection point from the platform or other control area to the subsea or other region where the manifold 100 operates. Sub-manifolds 104, 106, 108, 110 may be considered peripheral sub-manifolds and serve to direct the hydraulic control signals to the various connected functions. Such functions include, without limitation, blow out preventers, shear rams, and annulars. While, in the embodiments of FIG. 1 is shown with the central sub-manifold 102 physically centrally located amongst peripheral sub-manifolds 104, 106, 108, 110 it should be understood that this is not necessarily the case. For example, in a case where fewer peripheral manifolds are present, the central sub-manifold 102 may not be physically located in the center of the manifold 100, but would perform the same function as described herein.

Manifolds provide predetermined and/or prearranged fluid pathways that comprise hydraulic circuits or portions of hydraulic circuits. Functions of hydraulic control circuitry may be based on the physical pathways inside the one or more connected manifolds. Various hydraulic valves may be used in conjunction with manifolds to provide more complex functionality. While the present disclosure is not intended to be limited to a particular hydraulic circuit or function, for purposes of full disclosure, a hydraulic pathways 110, 114 inside the central sub-manifold 102 are shown.

It should be understood that there may be many other hydraulic pathways in the central sub-manifold. These may be interconnected to form portions of hydraulic circuits implementing various functions. The hydraulic pathways inside sub-manifolds 102, 104, 106, 108, 110 may be drilled, bored, or a machined or otherwise placed into a solid block of material (such as high strength steel) as is known in the art. Hydraulic pathways may enter at different angles and directions into the associated sub-manifold and may join to other pathways to complete control circuitry or functionality. In some embodiments, necessary control valves are placed in or on peripheral sub-manifolds 104, 106, 108, 110 but valves are not necessarily limited to such locations.

Where the function of a hydraulic circuit requires a fluid pathway in one sub-manifold to pass into another, the adjacent sub-manifold can have an adjoining fluid pathway. In the illustrated example of FIG. 1, hydraulic pathway 110 in the central sub-manifold 102 connects to example fluid pathway 112 in peripheral sub-manifold 108. Hydraulic pathway 114 in central sub-manifold 102 connects to example fluid pathway 116 in peripheral sub-manifold 110.

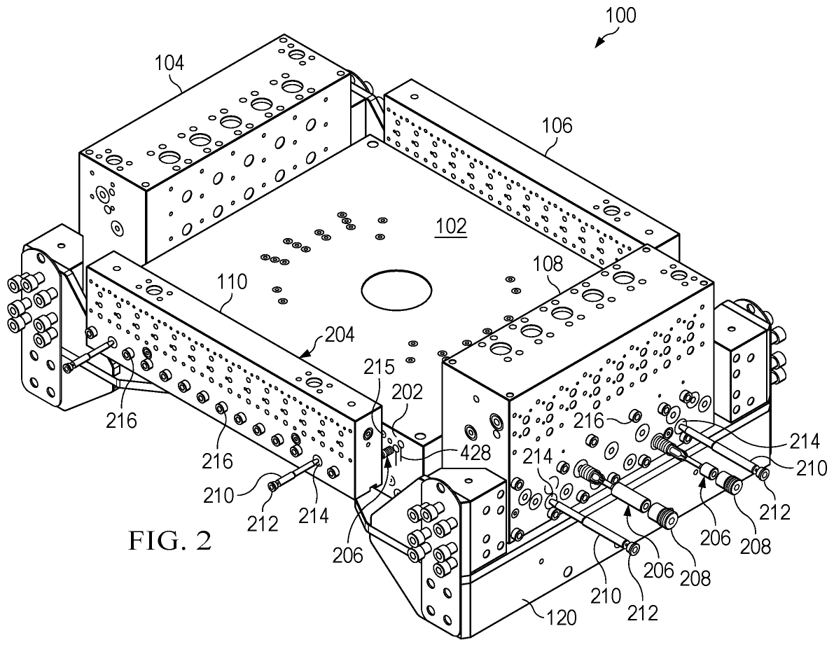

Referring now to FIG. 2, a partially exploded perspective view of the multi-plate manifold 100 is shown. The sub-manifolds 102, 104, 106, 108, 110 may be rectilinear or at least generally rectilinear in outside geometry. In such case, adjacent faces, or mating faces, of the sub-manifolds will be planar or at least generally planar. Mating faces could have corresponding curved surfaces at the potential cost of more complex machining operations to form such sub-manifolds.

As shown in FIG. 2, central sub-manifold 102 includes a mating face 202 that joins to mating face 204 of peripheral sub-manifold 110. Using bolts 216 or other fasteners known to the art, the mating faces 202, 204 may be joined together (bolts 216 are illustrative only and more or fewer may be used as needed). When properly aligned and assembled, the passageways 114, 116 (FIG. 1) will be contiguous, or at least provide suitable fluid flow between them for the necessarily hydraulic function to be achieved. In order to achieve proper alignment, one or more alignment pins 210 may be employed. Each alignment pin 210 may fit into an opening 214 that is indexed to a corresponding opening 215 on the central sub-manifold. Use of two alignment pins 210 (and associated openings 214, 215) may ensure that the adjacent sub-manifolds are properly aligned, even where multiple identical bolt holes are utilized. Only if both alignment pins 210 are able to be properly inserted would the adjacent sub-manifold have proper alignment. More than two alignment pins 210 could be utilized so long as the arrangement is such that all pins can only be placed when the adjacent sub-manifolds are properly aligned. Threaded caps 212 may retain the alignment pins 210 in place.

With adjacent sub-manifolds properly joined and with mating faces affixed together, it may remain necessary to provide sealing against hydraulic leaks. Embodiments of the present disclosure provide such sealing or closure of the associated hydraulic circuit utilizing one or more seal-subs 206.

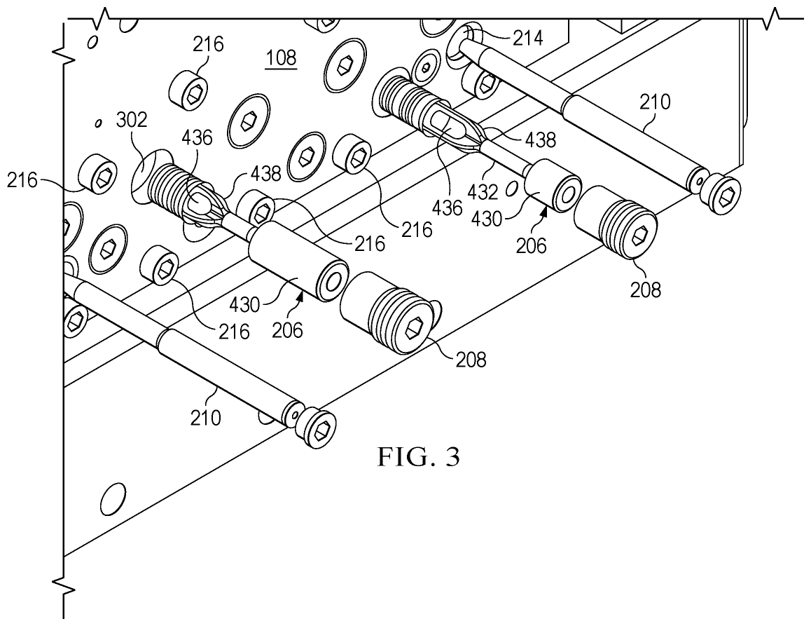

Referring now also to FIG. 3 a partially exploded perspective end view of the multi-plate manifold of FIG. 1 is shown. The seal-subs 206 may occupy a portion of adjacent jointed hydraulic passageways (e.g., passageways 110 and 112, or passageways 114 and 116, as shown in FIG. 1) to provide a sealing or closure function. Seal-subs 206 may be inserted through openings 302 defined the peripheral sub-manifolds (e.g., 108). A retaining cap 208 may thread into an outer portion of the respective opening 302 to secure the seal-sub 206 in its proper location.

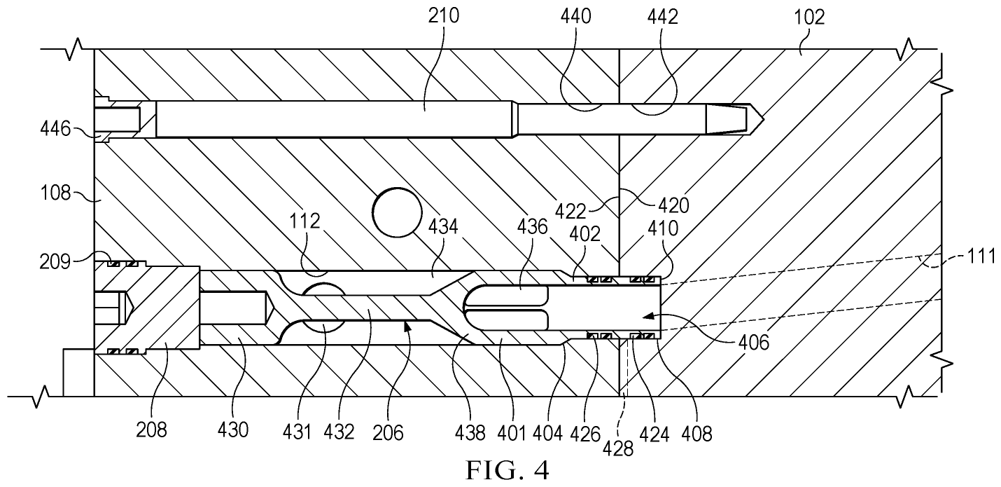

Referring now to FIG. 4, a close up, side cutaway view illustrating a seal-sub 206 hydraulically interconnecting adjacent sub-manifolds 102, 108 according to aspects of the present disclosure is shown. Interior passageways of the sub-manifolds 102, 104, 106, 108, 110 may be round, as would be produced by drilling or boring. The seal-subs 206 may also have portions that are round or generally cylindrical such that their rotational orientation is not critical. As illustrated the seal-sub 206 may be inserted into opening 302 in the peripheral sub-manifold 108. The seal-sub 206 may have portions thereof that are confirming to the diameter of passageway 112 such that the seal-sub 206 does not have any radial or later play, or does not have enough radial or later play to fail to appropriately seal the associated components (e.g., the central sub-manifold 102 and peripheral sub-manifold 108). When held in place by the cap 208, the seal-sub 206 may fit into the passage 112 way with little or no axial or length-wise play, or little enough of such play that it fails to appropriately seral the associated components (e.g., the central sub-manifold 102 and peripheral sub-manifold 108).

The seal-sub 206 may have an interior end 401 with inwardly tapered exterior portion 402 received into an inwardly tapered interior end portion 404 of the passage 112. A central passage 406 of the interior end 401 of the seal-sub 206 may have a diameter matching or substantially matching an inner diameter of passageway 110 in central sub-manifold 102. An outer end 408 of the passageway 110 may be relieved or widened to accommodate the interior end 401 (or the tapered portion 402 thereof) of the seal-sub 206. A shoulder 410 may be defined where the diameter of the passageway 110 changes and provides a stop for the seal-sub 206 (in addition to, or instead of, a stop being provided by the tapered interior end 404 of the passage 112).

The interior end 401 of the seal-sub 206, possibly the tapered portion 402 thereof, may span the interface between seal face 420 of sub-manifold 102 and seal face 422 of sub-manifold 108. One or a plurality of o-rings 424 may fit between the widened outer portion 408 of the passageway 110 and the interior end 401. One or a plurality of o-rings 226 may fit between the inward tapered interior end 402 of the passage 112 and the inner end 401. One or more o-rings 209 may be utilized on the cap 208 and/or on the outer end 430 of the seal-sub 206 to guard against leakage to the outside of the sub-manifold 108.

It should be understood that the seal-sub 206 may not have a tapered interior end 401 in all embodiments (see, e.g., FIG. 3). Correspondingly, passage 112 is not tapered in all embodiments.

O-rings or other sealing mechanisms can sometimes leak and need to be repaired. In order to quickly identify the location of a leak, a witness passage may be defined below the seal-sub in one or both seal faces 420, 422. As illustrated, a single channel 428 defines the witness passage. Any leakage or seal failure will therefore be easily diagnosed. The channel 428 need not necessarily be defined straight downward, but may nevertheless be arranged such that leaking fluid is drained under gravity where it may be seen on or below the interface between seal faces 420, 422.

The seal-sub 206 may have an outer end 430 that is cylindrical with a diameter matching or substantially matching that of the passage 112. The inner end 401 may be cylindrical with a dimeter matching that of the passage 112. The tapered portion 402 of the seal-sub 206 may have a diameter matching that of the tapered portion 404 of the passage 404 and or the widened portion 408 of the passageway 110. A medial portion 432 of the seal-sub 206 may have a smaller diameter or otherwise be spaced apart from the interior of passage 112 and thereby define a flow region 434 inside the passage 112, between the inner end 401 and outer end 430 of the seal-sub.

One or a plurality of ports 436 may be defined in the inner end 401 of seal-sub 206 to allow fluid flow between the flow region 434 and the central passage 406 of the seal-sub 206 thus providing an open fluid pathway between the passage 110 and the passage 112. The inner end 401 of the seal-sub 206 may comprise one or more vanes 438 spanning from the larger diameter of the inner end 401 into the smaller diameter of the medial portion 432 that are spaced apart to define the ports 436 (see also, FIG. 3).

The interior end 401 specifically and the seal-sub 206 generally may have a length that allows some separation between sealing plates 420, 420 while the fluid pathway between passage 110 and passage 112 remains uncompromised and free, or substantially free, of leakage, even under pressure. The integrity of hydraulic circuits and seals between sub-manifolds connected via seal-subs according to the present disclosure remains even with the expected hydraulic spikes encountered in subsea systems.

For purposes of illustration and additional understanding, a transverse passage 430 can be seen leading from passage 112 of sub-manifold 108. The passage 430 is only for illustration but could lead to another portion of the control circuit, a valve, etc. Only a portion of the sub-manifolds 102, 108 is illustrated in FIG. 4 to highlight the structure and function of the seal-subs 206. It should also be understood that other interfaces and connections between adjacent sub-manifolds 102, 104, 106, 108, 110 may utilize the same or a substantially similar arrangement as that shown in FIG. 4. In some cases, sub-manifolds may be interconnected utilizing a combination of seal-subs 206 as shown and described herein along with other known prior art methods (e.g., gaskets). Such combinations could be employed at different interfaces or on the same interface (e.g., for cost reduction or on a non-critical circuit).

Also shown in FIG. 4 is an example placement of an alignment pin 210. The pin 210 may be placed into a pin passage 440 defined through the peripheral sub-manifold 108 and into a pin passage 442 in the central sub-manifold 102. The pin 210 may have a shape cooperating with any tapers or shoulders in the passages 440, 442. The pin 210 may be retained against inadvertent retraction by a plug 446.

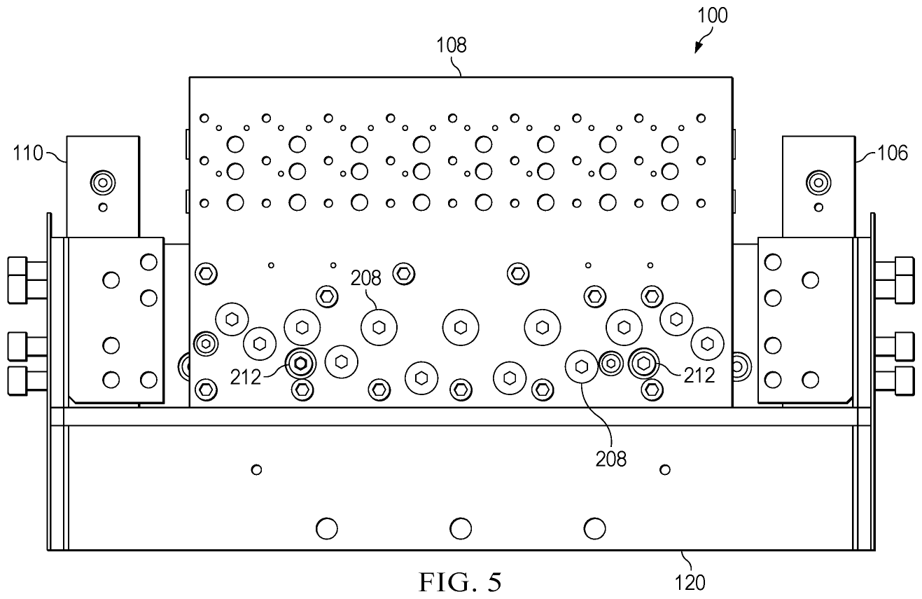

Referring now to FIG. 5, an end view of the multi-plate manifold of FIG. 1 is shown. It should be appreciated that a manifold structure may comprise additional components. For example, additional sub-manifolds, such as sub-manifold 507 shown in outline, could be attached to other of the sub-manifolds 104, 106, 108, 110. In other words, sub-manifolds can connect to other sub-manifolds. Sub-manifolds may interconnect hydraulically to other sub-manifolds using seal-subs 206. In some cases, where possible, additional sub-manifolds may be machined from the same monolith block to further reduce the likelihood of leaks.

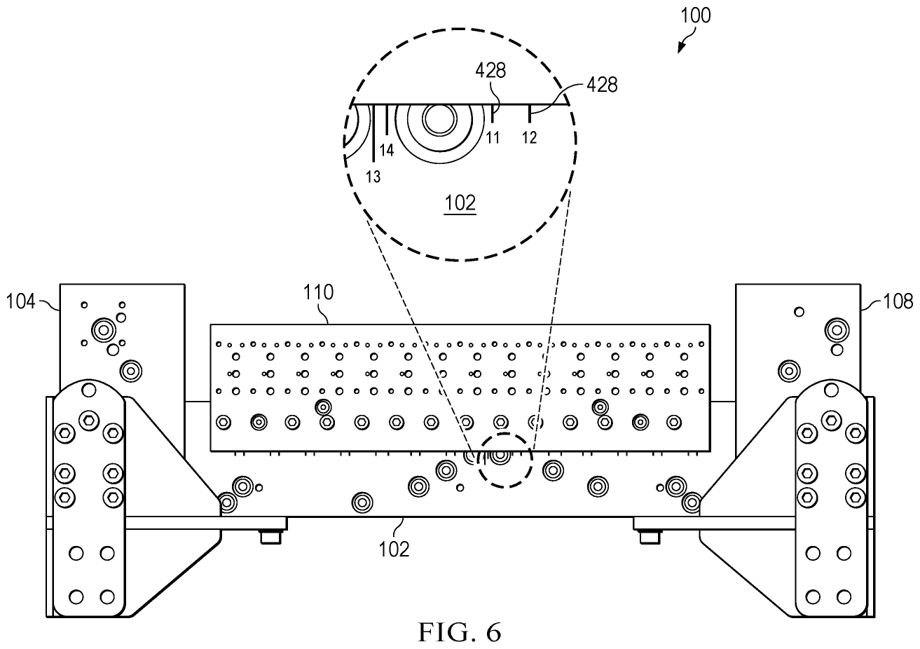

Referring now to FIG. 6 is a side view of the multi-plate manifold of FIG. 1 is shown. From the closeup inset, a plurality of channels 428 can be seen defined in the exterior of central sub-manifold 102 running downward from the seal face (covered by sub-manifold 110). Each of the channel 428 may be labeled and associated with a specific seal-sub. Leaking at a particular channel 428 can quickly indicate which connection is compromised. In the event that a seal-sub 206 needs to be replaced, this can be done from the exterior of the sub-manifold 102, 104, 106, 108, 110 without separating the sub-manifolds.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

1. A manifold comprising:
a first sub-manifold defining a first fluid passage;
a second sub-manifold defining a second fluid passage; and
a seal-sub occupying an interface between the first and second fluid passage and that seals against the first and second fluid passages to prevent fluid leaks at the interface;
wherein the first sub-manifold defines an opening for receiving the seal-sub into the first fluid passage from outside the first sub-manifold that is separate from the interface.

2. The manifold of claim 1, further comprising first and second pairs of indexed openings defined in the first and second sub-manifolds that receive first and second alignment pins with the first and second fluid passages are aligned.

3. The manifold of claim 1, wherein the seal-sub has a first end with at least one seal contacting the first fluid passage and at least one seal contacting the second fluid passage.

4. The manifold of claim 1, wherein the seal-sub comprises first and second cylindrical ends spaced apart and interposed by a medial portion, the medial portion being recessed to define a flow region in the first passage.

5. The manifold of claim 4, wherein the first end of the seal-sub defines a central passage in fluid communication with the first fluid passage.

6. The manifold of claim 5, wherein the first end of the seal-sub defines a port providing fluid communication between the central passage and the flow region.

7. The manifold of claim 1, further comprising a plug fitting into the opening in the first manifold for receiving the seal-sub that retains the seal-sub in position at the interface between the first and second fluid passages.

8. The manifold of claim 1, wherein the interface between the first and second fluid passages is defined at a joining of first and second seal faces of the first and second sub-manifolds, respectively.

9. The manifold of claim 8, wherein the first and second seal faces are planar.

10. The manifold of claim 8, further comprising a leak indicating drain channel in the first seal face leading from the interface between the first and second fluid passages to a location beyond the first and second seal faces.

11. The manifold of claim 8, further comprising a leak indicating drain channel in the second seal face leading from the interface between the first and second fluid passages to a location beyond the first and second seal faces.

12. A method of joining first and second sub-manifolds defining first and second fluid passages, comprising:
providing first and second seal faces on the first and second manifolds, the first and second fluid passages terminating at the first and second seal faces, respectively;
placing alignment openings passing through the first sub-manifold and into the second manifold when the first and second fluid passages are aligned;
placing alignment pins into the alignment openings;
defining an exterior opening into the first fluid passage that is accessible from outside the first sub-manifold through a location other than the first seal face;
providing a seal-sub having an elongate body with first and second ends spaced apart by a recessed medial portion, the first end defining a central passage and a port from the central passage to an outside of the medial portion;
inserting the seal-sub into the exterior opening and into a position where the first end passes through the first and second seal faces; and
fastening the first and second seal faces into a fixed position with respect to one another.

13. The method of claim 12, further comprising retaining the seal-sub in the position where the first end passes through the first and second seal faces by inserting a plug into the exterior opening.

14. The method of claim 12, further comprising retaining the seal-sub in the position where the first end passes through the first and second seal faces by providing a shoulder in the second passage.

15. The method of claim 12, further comprising retaining the seal-sub in the position where the first end passes through the first and second seal faces by providing cooperating tapered regions in the first fluid passage and the first end of the seal-sub.

16. A seal-sub having for connecting adjacent first and second hydraulic passages into first and second seal faces of a manifold, the seal sub comprising:
a first end occupying a portion of both the first and second passages and defining a central passageway therein;
a second end spaced apart from the first end and extended into the first hydraulic passage;
a medial portion interposing the first end and second end and having a diameter smaller than the first end and smaller than the second end to define a flow space between the first end and the second end inside the first hydraulic passage;
at least one port providing fluid communication between the flow space and the central passageway.

17. The seal-sub of claim 1, wherein the first end and the second end are at least partially cylindrical.

18. The seal-sub of claim 1, wherein the second end is at least partially cylindrical and tapers between first and second diameters.

19. The seal-sub of claim 1, wherein the at least one port is defined by a plurality of vanes between the medial portion and the second end.

20. The seal-sub of claim 1, further comprising at least a first o-ring interposing the second end and the first passage and at least a second o-ring interposing the second end and the second passage.
